(19) United States
(12) Patent Application Publication
(10) Pub. No.: US 2024/0152640 A1
(43) Pub. Date: May 9, 2024

(54) MANAGING ACCESS TO DATA STORED ON A TERMINAL DEVICE

(71) Applicant: Telefonaktiebolaget LM Ericsson (publ), Stockholm (SE)

(72) Inventors: Saket RUSTAGI, Delhi (IN); Vishal GARG, Faridabad (IN); Yukti KAURA, New Delhi (IN)

(21) Appl. No.: 18/279,803

(22) PCT Filed: Mar. 3, 2021
(86) PCT No.: PCT/IN2021/050197

§ 371 Date: Aug. 31, 2023

(51) Int. Cl. G06F 21/62

(52) U.S. Cl. CPC G06F 21/6218

(57) ABSTRACT

A method for managing access to data stored on a terminal device, the method at the terminal device including: receiving, from a first application executing on the terminal device, a request for access to a first type of stored data; receiving, as a user input, a first indication of whether the first application is to be allowed: full access to the first type of stored data, partial access to the first type of stored data, or no access to the first type of stored data; and providing the first application full, partial or no access to the first type of stored data according to the first indication.

### TECHNICAL FIELD

This disclosure relates to methods and apparatuses for managing access to data stored on a terminal device.

### BACKGROUND

The increasing use of smartphones, tablets, personal digital assistants and other terminal devices across the globe, and the increase of available applications (e.g. in online application stores) has led to an increasing concern for user privacy. In particular, there are concerns about the amount of information or data that is being accessed by third party applications installed on such devices. It is very common for applications (also referred to herein as apps) to request permission for access to different types of data stored on the device, e.g. to “Read SMS”, “Files/Storage”, “Photo Gallery”, “Camera”, “Contacts” and so on. If permission is granted by the user of the device, the app is able to access all of the stored data of that type, and as such, the app can often gain access to sensitive data such as personally identifiable information, bank account numbers, bank account balance, other sensitive business transactions, family pictures, health records, individual's addresses and so on. Such information requires strong protection.

The threat to individual privacy has been recognized by computer scientists and government agencies around the world. Various legislation has been passed and new legislation is being considered around the world to protect sensitive information. Many industries have specific legislation governing the collection and use of an individual's sensitive information while some regulations deal with multiple industries. There are financial industry regulations, medical industry regulations (Health Industry Portability and Accountability Act, HIPAA), child protection legislation (Children's Online Privacy Protection Act, COPPA), the European Union Data Protection Directive, and many other examples.

Short message service (SMS) is used to exchange text messages between terminal devices and is an example of a service whose messages can contain sensitive information. SMS messages exchanged or received by a user can contain, for example: identity numbers like a social security number, an insurance registration number etc., information about bank accounts, credit cards etc., balance in bank accounts, salary credit information, purchase history, medical history and reports, and trade information. When a user installs a third party app on their terminal device it can often request permission to read SMS for “Auto Verification”. This means that a remote server associated with the app will send a security code (also referred to herein as a one-time password) to the user via SMS and, if the permission is granted, the app can automatically read the SMS message to obtain the security code and verify the user. This automatic reading is an alternative to the user having to manually copy the code from the SMS into the app. In many circumstances, users are forced to accept a permission request in order for the application to be installed and/or function properly. However, by granting permission the user ends up sharing all stored SMS messages (i.e. not just the SMS message including the security code), and these other messages may include sensitive information. Misuse of this data by malicious applications may result in privacy breaches and sensitive data leakage.

There are few, relatively limited ways to protect the sensitive information stored on a terminal device. The user can remove or reject the permission for an app to read SMS or access files, however this may lead to reduced efficiency or functionality of an app and other performance issues. Alternatively, separate protected storages areas can be created that are not accessible to apps, however this may require skilled expertise or may itself require the use of third party apps.

Therefore there is a need for improved techniques that reduce the security risks associated with the accessibility of sensitive information on a terminal device.

### SUMMARY

Certain aspects of the present disclosure and their embodiments may provide solutions to the above or other challenges. Techniques are proposed for improving the management of access to data stored on a terminal device (e.g. wireless device (WD) or user equipment (UE)). The result is the implementation of an improved security mechanism in a terminal device which allows a user to better control the data access provided to third party applications.

According to a first aspect, there is provided a method performed by a terminal device for managing access to data stored on a terminal device. The method comprises: receiving, from a first application executing on the terminal device, a request for access to a first type of stored data; receiving, as a user input, a first indication of whether the first application is to be allowed: full access to the first type of stored data, partial access to the first type of stored data, or no access to the first type of stored data; and providing the first application full, partial or no access to the first type of stored data according to the first indication.

According to a second aspect, there is provided a method performed by a data analysis function for managing access to data stored on a terminal device. The method comprises determining a first set of rules and/or training a first machine learning model. The first set of rules and/or first trained machine learning model is for identifying a subset of stored data of a first type that is not to be accessed by a first application executing on the terminal device in the event that a user of the terminal device indicates the first application is to be allowed partial access to stored data of the first type. The method at the data analysis function further comprises sending the first set of rules and/or the first trained machine learning model to the terminal device.

According to a third aspect, there is provided a terminal device for managing access to data stored on the terminal device. The terminal device is configured to: receive, from a first application executing on the terminal device, a request for access to a first type of stored data, and receive, as a user input, a first indication of whether the first application is to be allowed: full access to the first type of stored data, partial access to the first type of stored data, or no access to the first type of stored data. The terminal device is further configured to provide the first application full, partial or no access to the first type of stored data according to the first indication.

According to a fourth aspect, there is provided a data analysis function for managing access to data stored on a terminal device. The data analysis function is configured to determine a first set of rules and/or train a first machine learning model. The first set of rules and/or first trained machine learning model is for identifying a subset of stored data of a first type that is not to be accessed by a first application executing on the terminal device in the event that a user of the terminal device indicates the first application is to be allowed partial access to stored data of the first type. The data analysis function is further configured to send the first set of rules and/or the first trained machine learning model to the terminal device.

According to a fifth aspect, there is provided a terminal device for managing access to data stored on the terminal device. The terminal device comprises a processor/processing circuitry and a memory, said memory containing instructions executable by said processor/processing circuitry whereby the terminal device is operative to: receive, from a first application executing on the terminal device, a request for access to a first type of stored data, and receive, as a user input, a first indication of whether the first application is to be allowed: full access to the first type of stored data, partial access to the first type of stored data, or no access to the first type of stored data. The terminal device is further operative to provide the first application full, partial or no access to the first type of stored data according to the first indication.

According to a sixth aspect, there is provided a data analysis function for managing access to data stored on a terminal device. The data analysis function comprises a processor/processing circuitry and a memory, said memory containing instructions executable by said processor/processing circuitry whereby the data analysis function is operative to determine a first set of rules and/or train a first machine learning model. The first set of rules and/or first trained machine learning model is for identifying a subset of stored data of a first type that is not to be accessed by a first application executing on the terminal device in the event that a user of the terminal device indicates the first application is to be allowed partial access to stored data of the first type. The data analysis function is further operative to send the first set of rules and/or the first trained machine learning model to the terminal device.

According to a seventh aspect, there is provided a computer program product comprising a computer readable medium having computer readable code embodied therein. The computer readable code is configured such that, on execution by a suitable computer or processor, the computer or processor is caused to perform the method according to the first and/or the second aspect, or any embodiment thereof.

The techniques disclosed herein enable users to better control the access granted to applications to data stored on a terminal device, and hence restrict or reduce the ability of applications to steal the user's sensitive information. The techniques can provide security policy enforcement at the level of the terminal device by identifying and masking sensitive information where the user does not want to grant the application full access to the particular type of data. The terminal device can selectively mask or restrict sensitive information contained within a particular type of data, e.g. SMS messages or contact information, including context sensitive information, in order to enable information within that type of data that is not sensitive to be safely shared and/or made accessible to requesting apps without disclosure of sensitive information.

Thus, the techniques disclosed herein allow data to be shared with authorised third-party applications (i.e. applications for which the user has granted the appropriate permission) while reducing the risk of exposing personal sensitive information. Third-party applications are increasingly uploading the data that they acquire from terminal devices to cloud-based services. Therefore, the techniques disclosed herein also significantly reduce data security risks associated with this increasing cloud adoption. The proposed techniques are cost effective and less complicated than encryption. In particular, these techniques minimise human intervention in identifying and restricting access to sensitive data, while reducing security risks associated with the accessibility of sensitive information. They also reduce the security risks associated with the accessibility of sensitive information while allowing users to provide the needed access to third party apps without any inconvenience.

Other aspects and embodiments of the techniques described herein will be understood by those skilled in the art based on the description below and the accompanying drawings.

### BRIEF DESCRIPTION OF THE DRAWINGS

Some of the embodiments contemplated herein will now be described more fully with reference to the accompanying drawings, in which:

FIG. 1 is an illustration of elements of a graphical user interface according to an existing technique for digital security management;

FIG. 2 is a flow chart illustrating a method of operating a terminal device according to various embodiments;

FIG. 3 is a flow chart illustrating a method of operating a data analysis function according to various embodiments.

FIG. 4 is an example of the selective masking of SMS data stored in a terminal device;

FIG. 5 is a schematic illustrating embodiments of the techniques described herein;

FIG. 6 is a schematic showing user equipment architecture according to various embodiments;

FIG. 7 is a block diagram of a terminal device according to various embodiments; and

FIG. 8 is a block diagram of a data analysis function according to various embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

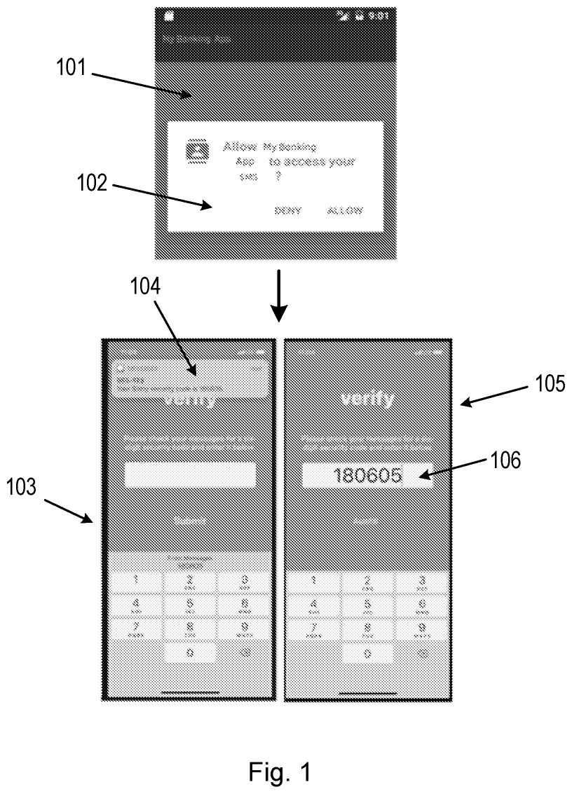

FIG. 1 illustrates elements of a graphical user interface according to an existing technique for managing access to data stored on a terminal device. In this example, an application “My Banking” installed on the terminal device sends a request to the terminal device for access to “SMS data”. The terminal device presents a notification to the user providing the user with the option to deny or allow the My Banking app to access the SMS data stored on the terminal device. Display view 101 in FIG. 1 shows part of a user interface on a display screen of the terminal device that includes the notification 102 to the user.

The permission to access the SMS data is requested by the My Banking app as an SMS text message is to be sent to the terminal device by a bank server comprising a security code, and this code will need to be entered into the My Banking app for the My Banking app to start or continue to operate (e.g. to authenticate the terminal device and My Banking app instance to the bank's server). If the user selects to “allow” this permission, the My Banking app can read the SMS text message and retrieve the security code itself, saving the user from having to manually check their messages and enter the code themselves. Display view 103 shows the security code entry screen, along with a notification 104 indicating the content of the newly received SMS message. Assuming the user has selected “allow”, the My Banking app will automatically populate the field for the security code, as shown by display view 105, in which the security code has been entered into the security code field 106.

If the user selects “deny”, the user will need to read the received SMS message and manually type the received security code into the security code field 106. However, in some cases selecting “deny” can prevent the application from functioning properly on the terminal device, for example if the My Banking app is programmed or configured to require the SMS permission in order to function. In other cases, permissions may be requested at the point of download of an application, for example from an online application store, and denying access to certain information can prevent an application from being installed or downloaded.

Briefly, the techniques disclosed herein provide for the improved safeguarding of user data by the terminal device. In particular when an application requests access to a type of data stored on the terminal device (e.g. SMS messages), the user is presented with the choice to provide the application full, partial or no access to the requested type of data. If the user indicates that the application should be allowed partial access, only data that is “needed” is shared or made available to the application, while masking out (i.e. not sharing) everything else. In some embodiments, data that is ‘needed’ comprises data that is not considered to be sensitive and/or contain private information for the user or terminal device. In some embodiments, the context of the request by application may be used to determine which data is considered to be sensitive and/or contain private information.

In some embodiments, the process of ‘masking’ the data is performed by the terminal device using one or more rules to determine which stored data of the relevant type can be shared under partial access, and which stored data of the relevant type should not be shared under partial access. In alternative embodiments, the process of masking data is performed by the terminal device using one or more cognitive models that are used to determine which stored data of the relevant type can be shared under partial access. The cognitive models can be trained and tuned at regular intervals by a data analysis function (DAF) that is separate from the terminal device. The data analysis function can also be referred to as a data analytics function. The terminal device can be considered as an inference engine for the cognitive model. In some embodiments, the data analysis function learns context sensitive regions of user's data aligned to the security and privacy policies which govern such classification.

In some embodiments, part or all of the techniques described herein can be considered to be performed via a security function operating and/or installed in the terminal device, hereinafter referred to as a “security assistant”. The security assistant acts to restrict the access that applications have to sensitive data stored on the terminal device when a user of the terminal device grants partial access to data of a particular type. The security function/security assistant may be implemented in the terminal device in a number of different ways. For example, the security assistant may be implemented using hardware, software, firmware, or any combination thereof. In some embodiments, the security assistant can be implemented in the form of an app or application (software application) that can be installed or pre-installed in the terminal device, and/or part of the operating system (OS) of the terminal device. In some embodiments, the security assistant includes or is part of an access control function in the terminal device that controls the permission requests/access rights of applications executing on the terminal device. In alternative embodiments, the security assistant is separate from an access control function in the terminal device, and the security assistant is called or used when the user permits ‘partial’ access to the access control function for a particular application and/or data type.

In parts of this description, SMS is used as an example of a type of data stored in a terminal device that can carry and include data that could be considered sensitive and ideally should not be shared to every application that requests access to SMS data. However, it should be understood that the disclosed techniques apply equally well to any type of data that may be stored on a terminal device. Other types of data typically stored on a terminal device for which access permission can be requested, include any of image data, video data, audio data, contact data, calendar data, call logs, terminal device location information, user files, measurements of the user by one or more sensors in the terminal device, or any other data stored in the terminal device including settings for the terminal device (such as storage capacity, battery information, Subscriber Identity Module (SIM) settings for voice/data, Long Term Evolution (LTE), etc.).

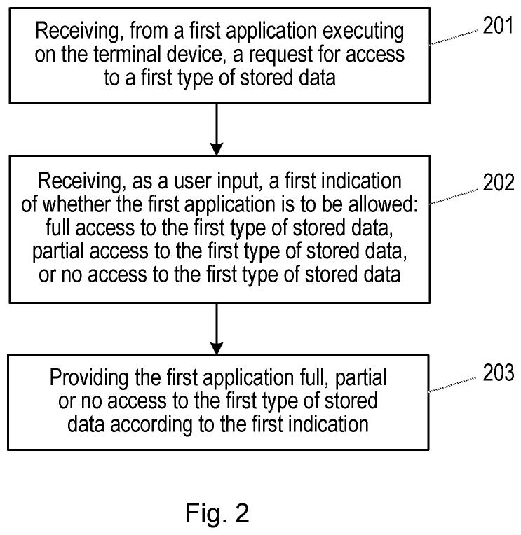

FIG. 2 is a flow chart illustrating a method for managing access to data stored on a terminal device according to various embodiments of the present disclosure. The method is performed by a terminal device, for example by a processing unit or processing circuitry in the terminal device. The method comprises a step 201 of receiving, from a first application (which is subsequently just referred to as ‘the application’) executing on the terminal device, a request for access to a first type of stored data. The request for access is a request by the first application to be granted permission by the user of the terminal device to access the stored data of the first type. For example, in the Android operating system, the request can be a request for a “runtime permission” that is required in order to access the stored data of the first type. The first application can be any type of software application running on the terminal device. The first type of stored data can be SMS data, image data, video data, audio data, contact data, calendar data, call logs, terminal device location information, user files, measurements of the user by one or more sensors in the terminal device, or any other data stored on the terminal device. In some embodiments, the request for access can be received by an access control function of the terminal device or by a security assistant.

FIG. 2 further comprises a step 202 of receiving, as a user input, a first indication of whether the first application is to be allowed: full access to the first type of stored data; partial access to the first type of stored data, or no access to the first type of stored data. The user input can be any suitable type of input. For example, the user input can comprise a button press, mouse click, a press or touch on a particular position of a touch screen of the terminal device corresponding to the desired option, a voice command, etc.

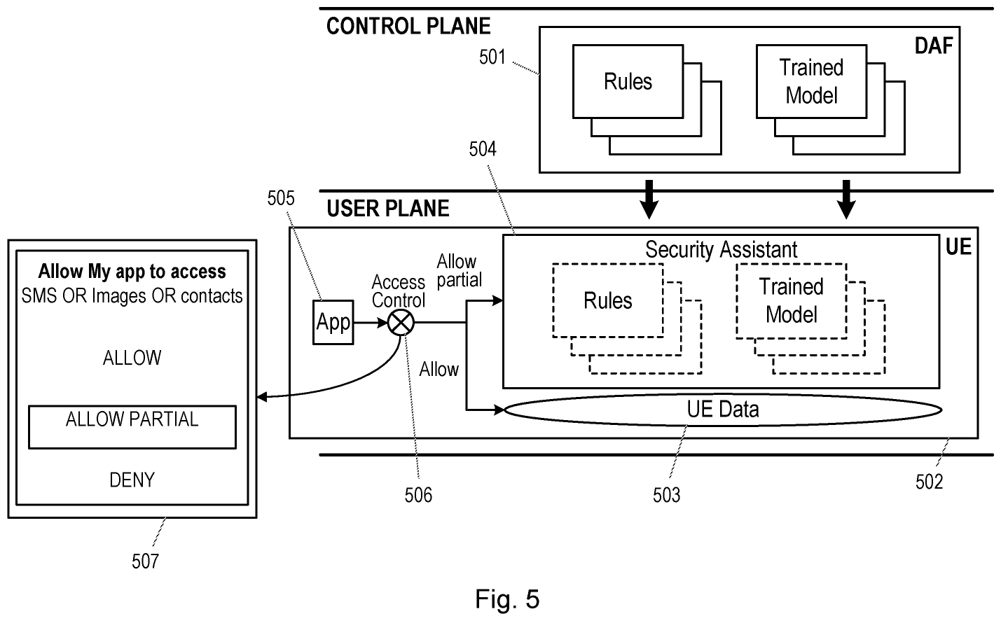

In some embodiments, the user input is in response to a request from the terminal device. In these embodiments, the method at the terminal device further comprises, after receiving the request for access from the first application, requesting a user to indicate whether the first application is to be allowed full access, partial access, or no access. This request can be presented to the user on the display screen of the terminal device as a pop-up notification or a push notification. For example, in the Android operating system, the request can be displayed as a “runtime permission prompt”. An example of such a request is shown in FIG. 5 and discussed further below. In alternative embodiments, the request and/or the options for response can be presented to the user audibly using one or more loudspeakers in, or connected to, the terminal device. The steps of requesting an indication and/or receiving the indication (step 202) can be performed by the access control function and/or the security assistant in the terminal device.

FIG. 2 further comprises a step 203 of providing the first application full, partial or no access to the first type of stored data according to the first indication. For example, in the event that the user indicates that the first application is to be allowed full access, the application has full access to the first type of stored data, i.e. access to all of the stored data of the first type. Thus, if the application subsequently requests retrieval of data of the first type, the data is provided by the terminal device to the application. In the event that the user indicates that the first application is not to be provided access to the first type of stored data, the application has no access to the stored data. Thus, if the application subsequently requests retrieval of data of the first type, the request is rejected and no data is provided to the application by the terminal device.

In the event that the user indicates that the first application is to be allowed partial access, the application has access to only some of the stored data of the first type. Thus, if the application subsequently requests retrieval of data of the first type, only some of the data of the first type is provided by the terminal device to the application. In these embodiments, partial access can be effected in a number of different ways. For example, partial access can be effected by omitting a subset of the data of the first type when sending the data of the first type to the application. Alternatively, partial access can be effected by anonymising or changing certain sensitive parts of the data of the first type when sending the data of the first type to the application.

In some embodiments, the access control function in the terminal device can handle the ‘full access’ and ‘no access’ permissions in a conventional manner, along with any subsequent data retrieval requests from the application when those permissions are granted by the user. In some embodiments, if partial access is permitted, the access control function can direct any subsequent request for retrieval of the data of the first type to the security assistant.

In the event that full access to the first type of stored data is provided to the application, the method can comprise a step of sending, to the application, an indication that full access has been granted. Furthermore, in the event that partial access to the first type of stored data is provided to the application, the method can also further comprise the step of sending an indication that full access has been granted. The application will therefore not be aware that only partial access has been granted, and will not be aware that it will not receive some of the data of the first type when trying to access that data. The application will therefore respond in the same way regardless of whether full or partial access to the stored data is permitted, and thus the use of the ‘partial access’ permission level is transparent to the application itself. This protects the user's sensitive data while enabling the user to experience the full functionality of the application executing on the terminal device.

Providing partial access to stored data can be achieved by ‘dynamic masking’. This means that the stored data of the first type can be evaluated dynamically (e.g. at the time of a request to retrieve that data) to determine which parts of the data can be shared with the application and which parts of the data should not be shared.

Two different methods of dynamic masking are discussed further below: view-based masking and proxy-based masking.

View-based masking maintains both the original version of the stored data of the first type and a masked version of that data in the same database or memory. The masked version of the data can be a copy of the stored data with a subset of the stored data removed, masked or anonymised (e.g. changed). Applications that are granted partial access are provided with the masked version of the data when attempting to retrieve the stored data of the first type. The decision of whether to show or provide the masked data (partial access) or the original data (full access) can be made in real-time, for example by the security assistant, based on the access granted to the application by the user. The security assistant can establish or create the masked version of the data from the stored data, and respond to data retrieval requests from the application using the masked version or original stored data as appropriate.

Thus, in some embodiments, in the event that partial access to the first type of stored data is provided to the application, the method further comprises a step of providing a first copy of the stored data of the first type to the first application. The first copy of the stored data comprises the stored data with a subset of the stored data removed, masked or anonymised.

Proxy-based masking effectively introduces a proxy layer between the application and the original stored data. In some embodiments, this proxy layer can be, or be provided by, the security assistant. If partial access is granted, the proxy layer operates to substitute parts of the result of the data retrieval request (the requested data) with masked or anonymised values. Therefore, in these embodiments, partial access comprises providing the stored data to the application with a subset of the stored data removed, masked or anonymised by the proxy layer. In the event that partial access to the first type of stored data is provided to the application, the method of FIG. 2 can further comprise a step of providing the stored data of the first type to the application, except for a subset of the stored data that is removed, masked or anonymised. Proxy-based masking provides data protection without the need to alter the original data.

Anonymised data can include data in which details that can be used to identify a person or similar (e.g. a bank account) have been removed or replaced with alternative details. Anonymising data can also include altering, changing or removing information from the data according to the context of the data retrieval request. This is discussed further below.

In some embodiments, the stored data (of a particular type) can be evaluated using a set of rules and/or a machine learning (ML) model to determine which parts of the stored data are sensitive and should not be provided to an application if the application is only granted partial access to the data. These rules and/or ML model can be generated by a data analysis function (DAF) that is separate from the terminal device. Thus, in some embodiments, the method shown in FIG. 2 can further comprise a step of receiving, from a data analysis function, a first set of rules and/or a first trained machine learning model for identifying a subset of the stored data of the first type that is not to be accessed by the first application when partial access to the first type of stored data is allowed. The set of rules and/or the trained model can be stored and used by the security assistant in the terminal device. The subset of the stored data that is not to be accessed by the first application can consist of data that has been classified by the first set of rules and/or the first trained machine learning model as sensitive. The set of rules and/or ML model can be used to generate the masked version of the stored data in the view-based masking approach, or used by the proxy layer when using the proxy-based approach.

The machine learning model can be in the form of one or more Neural Networks, a Long-short-term memory (LSTM) model or any other suitable type of machine learning model.

It is possible that the DAF may update the rules and/or models over time, for example based on better/more training data, and/or changes in a policy or other information (e.g. changes to data privacy regulations). Therefore method of FIG. 2 can further comprise a step of receiving, from the data analysis function, an updated first set of rules and/or an updated first trained machine learning model. In some embodiments, an updated set of rules and/or an updated trained machine learning model can be received regularly at predetermined time intervals. Trained models can be sent to (or synchronised with) the terminal device at a regular time interval determined by re-training cycles at the DAF. In other embodiments, an updated set of rules and/or an updated trained machine learning model can be received in response to a request by the terminal device (e.g. the security assistant) for an updated set of rules and/or an updated trained machine learning model. An updated set of rules and/or an updated trained machine learning model can also be received at any time.

In some embodiments, the method of FIG. 2 further comprises using the first set of rules and/or the first trained machine learning model (or a subsequently received updated set of rules and/or updated trained machine learning model) when partial access is allowed. This step can be performed dynamically and therefore, after the user indicates that an application should be granted partial access, the subset of the data that is not to be accessed can be determined. Thus, the step of using the first set of rules and/or the first trained machine learning model is performed after the step of receiving the first indication (step 202). In other words, the process of masking data can take place at or after the point that the partial access permission is granted. In alternative embodiments, the step of using the first set of rules and/or the first trained machine learning model is performed prior to both the step of receiving the request (step 201) and the step of receiving the first indication (202). Therefore, when the terminal device receives a request for access from an application, the subset of the stored data that is not to be accessed in the event the user allows partial access has already been identified.

The method shown in FIG. 2 can also be applied to further applications and/or further types of stored data. In some embodiments, the application may request access to a second type of stored data. The second type of stored data can be any one of: SMS, data, image data, video data, audio data, contact data, calendar data, call logs, terminal device location information, user files, measurements of the user by one or more sensors in the terminal device, or any other data stored on the terminal device. All of the embodiments described in relation to FIG. 2 can also be applied to this embodiment in relation to the second type of stored data. Thus, the method may comprise a step of receiving, from the first application, a request for access to a second type of stored data; and a step of receiving, as a user input, a second indication of whether the first application is to be allowed: full access to the second type of stored data; partial access to the second type of stored data, or no access to the second type of stored data. The method may also comprise a step of providing the first application full, partial or no access to the second type of stored data according to the second indication. The request for access to the second type of stored data may be received at the same time or a different time as the request in step 201.

In some embodiments, the terminal device may use a second set of rules and/or a second trained machine learning model to identify a subset of the stored data of the second type that is not to be accessed by the first application when partial access to the second type of stored data is allowed. In some embodiments, different types of stored data may require or use different sets of rules and/or different types of machine learning models in order to identify subsets of the stored data that is not to be accessed. For example, different types of machine learning model (and differently trained machine learning models) will need to be used to evaluate the content of SMS data for sensitive information and to evaluate the content of image data for sensitive information.

In some embodiments, the terminal device may receive a request for access to the first type of stored data from a second application executing on the terminal device. All of the embodiments described in relation to FIG. 2 can also be applied to this embodiment in relation to the second application. The method may comprise: receiving, from the second application, a request for access to the first type of stored data; receiving, as a user input, a third indication of whether the second application is to be allowed: full access to the first type of stored data; partial access to the first type of stored data, or no access to the first type of stored data; and providing the second application full, partial or no access to the first type of stored data according to the third indication. It will be appreciated that the user may provide the first application with one level of access (e.g. full access), while providing the second application with a different level of access (e.g. partial access). For example, the user may provide full access to SMS data for a banking application, while only providing partial access to SMS data for a game or social media application.

In some embodiments, the terminal device may use a different set of rules and/or a different trained machine learning model to identify a subset of the stored data of the first type that is not to be accessed by the second application when partial access to the first type of stored data is allowed. Thus, the level of partial access provided to the second application may be different to the level of partial access provided to the first application, and the level of partial access may depend on the second application itself (e.g. a greater level of partial access may be provided to a banking application than a game application). Alternatively, the level of partial access provided to the two applications may be the same.

As noted above, the set of rules and/or machine learning model can be specific to the type of data and/or to the type of application. The set of rules and/or machine learning model can also take into account the context and/or or purpose of the request. For example, if a banking app requests access to SMS data for the purpose of reading a security code sent from the bank's server, the model can provide partial access by only providing access to the relevant messages from the bank comprising a security code. The set of rules and/or machine learning model in this example can take this context into account and mask access to all other SMS messages as they will be classified as private/sensitive. Furthermore, with additional rule(s) defined, segregation of security code or one-time password notifications can be carried out based on the requester's identity (e.g. the telephone number from which the SMS message is received.

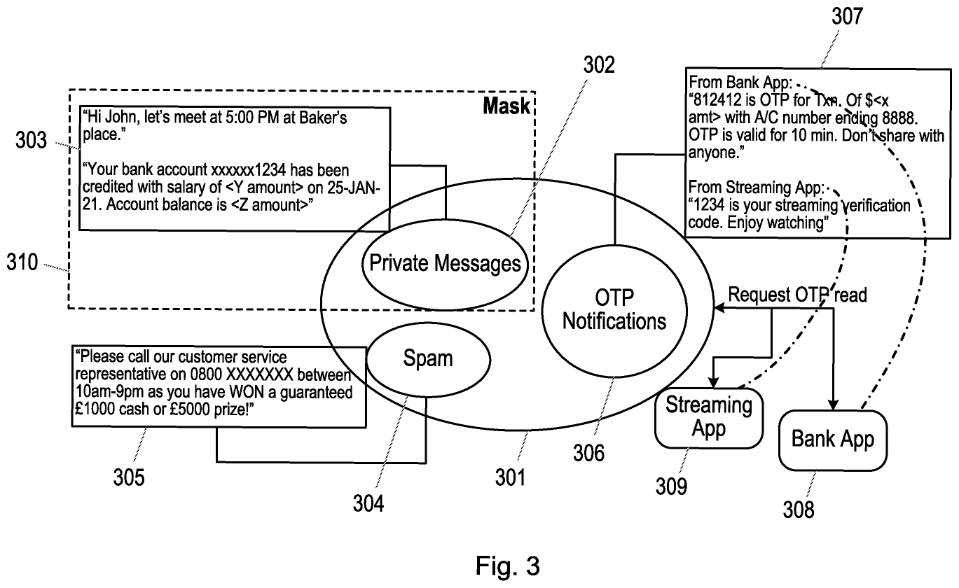

FIG. 3 is an example of the selective masking of SMS data stored in a terminal device. The entirety of the SMS data stored on the terminal device is represented by reference numeral 301, and, as an example from the user's point of view, includes three sub-categories of SMS messages. The first category is Private Messages 302, and two examples 303 are shown. One of these messages includes a name, and a time and location for a meeting. The second message is a message relating to a bank account that includes a bank account number, an amount of a deposit and the account balance. The second category is Spam 304, and an example 305 is shown of a message requesting the user to call customer services as the user has won a prize. The third category is OTP (One-Time Passcode) Notifications 306, and two examples 307 are shown. One of these messages includes a OTP from a bank relating to a payment and the other message includes a OTP for a streaming service to activate streaming to the terminal device.

A banking application 308 and a streaming application 309 are also shown. Both applications request permission to access SMS data. In both cases, partial access is granted by the user of the terminal device. In this case, the applications are only permitted to access part of the SMS data 301. The part of the SMS data 301 that is not to be accessed is determined using a set of rules and/or a trained ML model as described above.

The rules and/or ML model can analyse different aspects of the SMS messages 301 to determine if a particular message should be accessible when partial access is granted. For example, the rules and/or ML model can evaluate the presence of certain key words or phrases in the content of the message, such as names, times, telephone numbers, monetary amounts, words such as “bank account no.”, etc., and the telephone number from which the SMS message was received (for example the number may correspond to a known number for a bank).

In the example of FIG. 3, the rules and/or ML model can evaluate the SMS data 301 to identify messages that include sensitive/private information, and messages such as Private Messages 302 will be identified and noted as ‘masked’, which is indicated by box 310 since they include names, times, and bank account numbers. The Spam messages 304 may not be considered sensitive and so access can be permitted to these messages 304. Depending on the configuration of the rules and/or ML model, and optionally also the context of the permission request, the OTP Notifications messages 306 may be considered sensitive and therefore restricted when partial access is granted, or alternatively accessible when partial access is granted. For example, the rules and/or ML model may take into account context information associated with the request to access the SMS messages 301. Such context information can include an indication accompanying the permission request that the request is due to wanting to access a OTP that will be sent to the terminal device. In this case, the rules and/or ML model may determine that access can be provided to the OTP messages 306 when partial access to the SMS data 301 is granted. Alternatively, if no context information is provided, or the context information does not suggest that OTP access is required, the OTP Notifications 306 may be included in the masked portion 310 and not provided to the application. As another alternative, context information including an indication that the request is due to wanting to access a OTP can lead to only OTP Notifications 306 from a telephone number associated with the application to be provided under partial access, with all of the other stored OTP Notifications 306 being included in the masked portion 310.

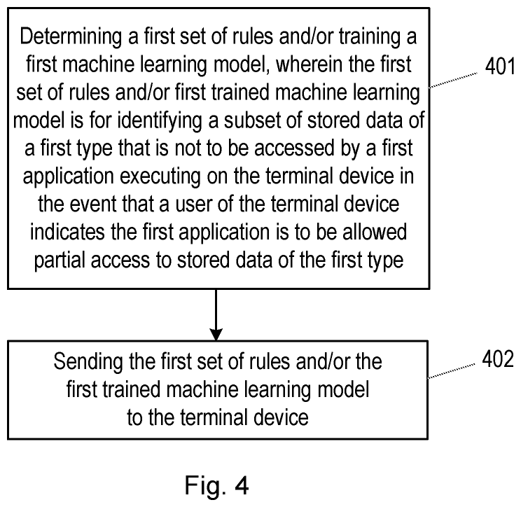

FIG. 4 is a flow chart illustrating a method for managing access to data stored on a terminal device according to various embodiments of the present disclosure. The method of FIG. 4 is performed by a data analysis function, for example by a processing unit or processing circuitry in the terminal device. The method comprises a step 401 of determining a first set of rules and/or training a first machine learning model. The first set of rules and/or first trained machine learning model are for identifying a subset of stored data of a first type that is not to be accessed by an application executing on a terminal device in the event that a user of the terminal device indicates the first application is to be allowed partial access to stored data of the first type. The first set of rules and/or ML model can be determined on the basis of one or more policies or user preferences relating to information that is typically sensitive and should not be accessed when partial access is granted to stored data. In the case of a ML model, the training data used to train the model can affect the type of information that is typically sensitive. For example, training data for evaluating SMS messages may include examples of SMS messages that have been annotated as containing sensitive information and examples of SMS messages that have been annotated as not containing sensitive information.

The machine learning model can be in the form of one or more Neural Networks, a Long-short-term memory model or any other suitable type of machine learning model. The type of ML model used can depend on the type of data to be evaluated by the model. The data used to train the ML model will also depend on the type of data to be evaluated by the model. For example, in embodiments in which the first type of stored data is SMS data, the model can be trained using SMS samples from a private federated SMS store or a public data set, whereas in embodiments in which the first type of stored data is image data, the model can be trained using sample images.

The method shown in FIG. 4 further comprises a step 402 of sending the first set of rules and/or the first trained machine learning model to the terminal device.

It is possible that the DAF may update the rules and/or models over time, for example based on better/more training data, and/or changes in a policy or other information (e.g. changes to data privacy regulations). Therefore in some embodiments, the method shown in FIG. 4 can further comprise a step of sending an updated first set of rules and/or an updated first trained machine learning model to the terminal device. The updated set of rules and/or updated trained machine learning model can be sent at regular time intervals. For example, trained models can be sent to/synchronised with the terminal device at a regular time interval determined by re-training cycles at the DAF. In other embodiments, they can be received in response to a request by the terminal device (e.g. the security assistant) for an updated set of rules and/or an updated trained machine learning model. An updated set of rules and/or an updated trained machine learning model can also be sent at any time.

The method of FIG. 4 can also be applied to further types of data. For example, the method can further comprise a step of determining a second set of rules and/or training a second machine learning model for use in identifying a subset of stored data of a second type that is not to be accessed by the first application in the event that a user of the terminal device indicates the first application is to be allowed partial access to stored data of the second type. All of the embodiments described in relation to FIG. 4 can also be applied to this embodiment in relation to the second type of stored data. The first type of stored data can be any of: SMS data, image data, video data or contact data, calendar data, call logs, terminal device location information, user files, measurements of the user by one or more sensors in the terminal device, or any other data stored in the terminal device. The second type of stored data can be a different one of these types of data. Thus, the set of rules and/or machine learning model can be specific to the type of stored data. For example, there can be different models trained for SMS data and images. The method can also comprise a step of sending the second set of rules and/or the second trained machine learning model to the terminal device.

The method of FIG. 4 can also be applied to further applications where different applications can have different levels of partial access to the stored data. For example, the method can further comprise a step of determining a further set of rules and/or training a further machine learning model that are for identifying a subset of stored data of the first type that is not to be accessed by another application in the event that a user of the terminal device indicates the second application is to be allowed partial access to stored data of the first type. The method can also comprise a step of sending the further set of rules and/or the further trained machine learning model to the terminal device.

The DAF of FIG. 4 may be operated by the terminal device manufacturer. In other embodiments, the DAF may be operated by a provider of an operating system executing on the terminal device or a network operator for the terminal device. Alternatively, the DAF may be operated by a combination of any two or more of: the terminal device manufacturer, a provider of an operating system executing on the terminal device and a network operator for the terminal device. In some embodiments, the DAF may be a 3GPP Network Data Analytics Function (NWDAF). The DAF can be implemented in any computing system, device or other environment.

The cognition for identifying a subset of stored data that is not to be accessed by an application when partial access to the stored data is allowed is derived from the DAF. The DAF can constantly build up intelligence based upon policies, privacy regulations and utility (usage) feedback.

FIG. 5 is a schematic illustrating embodiments of the techniques described herein. The methods are performed by a data analysis function 501 and a terminal device 502 (shown in FIG. 5 as a user equipment). As noted above, different embodiments arise regarding the implementation realisation of the techniques and the architectural placement of the security assistant and DAF. For example, they can be OS, UE manufacturer or service provider driven, or a hybrid in conjunction with a 3GPP NWDAF. FIG. 5 shows the terminal device 502 as a user plane function and the data analysis function 501 as a control plane (network) utility. The control plane may belong to or be provided by, an OS provider, the UE manufacturer or the telecom service provider via NWDAF (3GPP TS 29.520). The terminal device 502 includes stored data 503 and a security assistant 504 that has one or more rules and/or trained ML models that have been provided by the DAF 501. An application 505 is executing on the terminal device 502 and requests access to the stored data 503. The request is received by an access control function 506

According to the embodiments illustrated in FIG. 5, the user is presented with the choice to allow full access, masked (partial) access, or to deny access to the application 505, as shown by notification 507. This notification 507 can be presented visually to the user of the terminal device 502 and includes selectable options ‘allow’ (corresponding to allowing full access), ‘allow partial’ (corresponding to allowing partial access) and ‘deny’ (corresponding to not allowing access to the stored data 503). If the user specifies ‘allow’/full access, the access control function 506 in the UE can provide the application 505 with access to the requested data 503. If the user specifies ‘allow partial’/partial access, the access control function 506 can direct the request (and/or any subsequent retrieval request for that type of data) to the security assistant 504. The security assistant 504 will enable the application 505 to access the ‘masked data’ in the stored data 503. As noted above, the security assistant 504 can use a set of rules and/or machine learning techniques to generate masked data that can be provided to the application 505, optionally taking into account sensed contextual information associated with the request. The security assistant 504 can receive, from the DAF 501, an updated set of rules and/or an updated context-based machine learning model at scheduled intervals. The security assistant 504 can use the rules and/or model for context anonymization of ‘raw user data’ 503 before sharing the data with applications 505. Thus, the security assistant 504 in the UE 502 restricts an application's access to raw user data 503 containing sensitive information by acting as a secure layer that can mask certain user data.

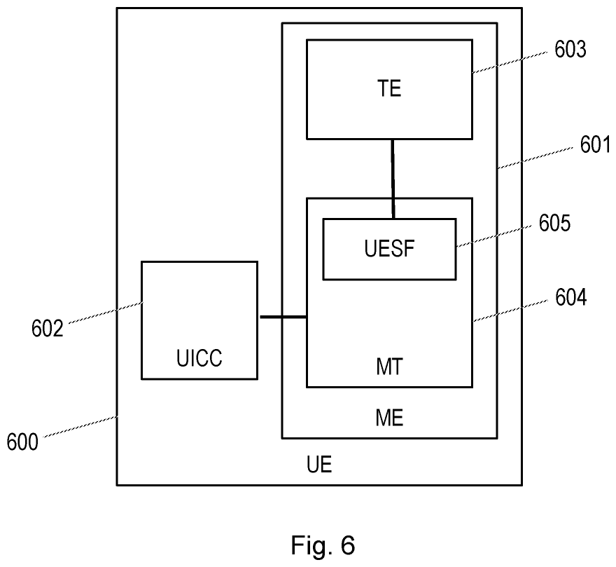

FIG. 6 is a schematic showing an exemplary architecture of a terminal device, which is taken from 3GPP TS 33.861 version 16.1.0 (3r d Generation Partnership Project; Technical Specification Group Services and System Aspects; Study on evolution of Cellular Internet of Things (CIoT) security for the 5G System; (Release 16)) (FIG. 6.6.2.1-1). As described in 3GPP TS 23.002 version 16.0.0 (“3rd Generation Partnership Project; Technical Specification Group Services and System Aspects; Network architecture (Release 16)”), the UE 600 is composed of a Mobile Equipment (ME) domain 601 and a Universal Integrated Circuit Card (UICC) domain 602. The ME domain 601 is subdivided into one or more Terminal Equipment (TE) 603 and Mobile Termination (MT) 604 components. The TE 603 is the part of the UE 600 containing the user applications that are susceptible to infection by malware. The MT 604 is the part of the UE 600 that is protected against infection by malware. The MT 604 itself is comprised of a UE security function (UESF) 605 which is capable of controlling the communication between the TE 603 and the MT 604 and limiting the impact of misbehaving user applications in the TE 603. In some embodiments disclosed herein, the security assistant is part of the UESF 605 in the MT 604 shown in FIG. 6.

The techniques disclosed herein can be deployed and/or implemented by any combination of terminal device manufacturers; operating system (OS) providers; and network operators. For example, terminal device manufacturers can implement the improved security end-to-end (E2E) with all the components including the security assistant and the data analysis function. OS providers can also implement the improved security E2E with all the components including the security assistant and DAF. Network operators could also implement the proposed idea E2E. For example the security assistant can be implemented via operator applications (e.g. “My Verizon” and “MyJio”). Data analysis functions can be implemented via, for example, a Network Data Analytics Function (NWDAF), as described in 3GPP TS 29.520 v17.1.0 (“3rd Generation Partnership Project; Technical Specification Group Core Network and Terminals; 5G System; Network Data Analytics Services; Stage 3 (Release 17)”). Alternatively, a mixed implementation could be used in which the security assistant is implemented via the OS provider and the DAF is implemented via an NWDAF operated by the network operator. For example, the network operator can build and supply the security policies to the security assistant at the terminal device for masking the sensitive data.

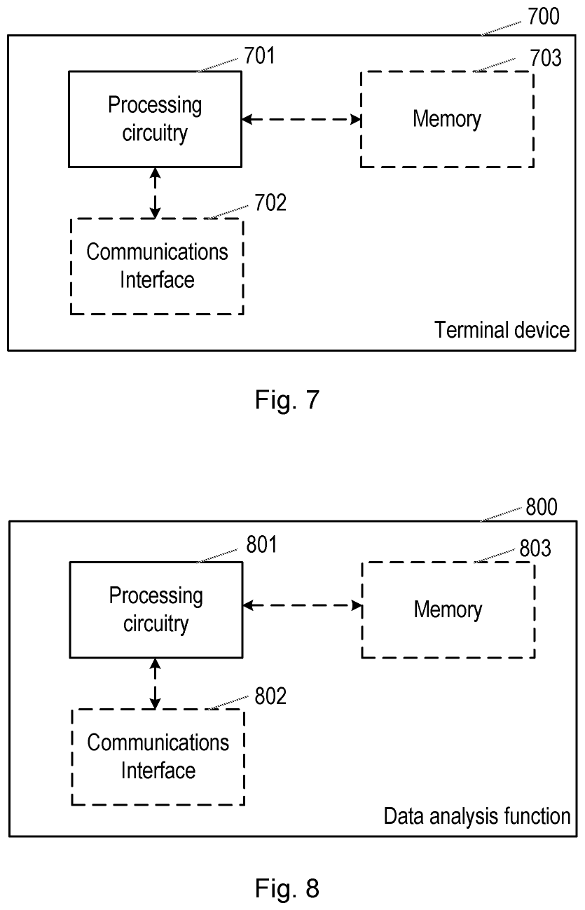

FIG. 7 is a simplified block diagram of a terminal device 700 according to various embodiments that can be used to implement the techniques described herein. It will be appreciated that the terminal device 700 may comprise one or more virtual machines running different software and/or processes. The terminal device 700 may therefore comprise one or more servers, switches and/or storage devices and/or may comprise cloud computing infrastructure that runs the software and/or processes.

The processing circuitry 701 controls the operation of the terminal device 700 and can implement the methods described herein in relation to the terminal device 700. The processing circuitry 701 can comprise one or more processors, processing units, multi-core processors or modules that are configured or programmed to control the terminal device 700 in the manner described herein. In particular implementations, the processing circuitry 701 can comprise a plurality of software and/or hardware modules that are each configured to perform, or are for performing, individual or multiple steps of the method described herein in relation to the terminal device 700. The processing circuitry 701 may implement the operations and/or functions of the security assistant described herein.

In some embodiments, the terminal device 700 may optionally comprise a communications interface 702. The communications interface 702 can be for use in communicating with other terminal devices or nodes, such as other virtual nodes. For example, the communications interface 702 can be configured to transmit to and/or receive from other nodes or network functions requests, resources, information, data, signals, or similar. The processing circuitry 701 may be configured to control the communications interface 702 of the terminal device 700 to transmit to and/or receive from other terminal devices or nodes or network functions requests, resources, information, data, signals, or similar.

The terminal device 700 may comprise a memory 703. The memory 703 can be used to store any of the types of data described above, such as SMS messages/data, image data, video data, audio data, contact data, calendar data, call logs, terminal device location information, user files, measurements of the user by one or more sensors in the terminal device, or any other data stored in the terminal device including settings for the terminal device (such as storage capacity, battery information, SIM settings for voice/data, LTE, etc.). In some embodiments, the memory 703 can be configured to store program code that can be executed by the processing circuitry 701 to perform the method described herein in relation to the terminal device 700. Alternatively or in addition, the memory 703 can be configured to store any requests, resources, information, data, signals, or similar that are described herein. The processing circuitry 701 may be configured to control the memory 703 to store any requests, resources, information, data, signals, or similar that are described herein.

FIG. 8 is a simplified block diagram of a data analysis function 800 according to various embodiments that can be used to implement the techniques described herein. In some embodiments, the DAF 800 is a NWDAF. It will be appreciated that the DAF 800 may comprise one or more virtual machines running different software and/or processes. The DAF 800 may therefore comprise one or more servers, switches and/or storage devices and/or may comprise cloud computing infrastructure that runs the software and/or processes.

The processing circuitry 801 controls the operation of the DAF 800 and can implement the methods described herein in relation to the DAF 800. The processing circuitry 801 can comprise one or more processors, processing units, multi-core processors or modules that are configured or programmed to control the DAF 800 in the manner described herein. In particular implementations, the processing circuitry 801 can comprise a plurality of software and/or hardware modules that are each configured to perform, or are for performing, individual or multiple steps of the method described herein in relation to the DAF 800.

In some embodiments, the DAF 800 may optionally comprise a communications interface 802. The communications interface 802 can be for use in communicating with other nodes, such as other virtual nodes. For example, the communications interface 802 can be configured to transmit to and/or receive from other nodes or network functions requests, resources, information, data, signals, or similar. The processing circuitry 801 may be configured to control the communications interface 802 of the DAF 800 to transmit to and/or receive from other nodes or network functions requests, resources, information, data, signals, or similar.

Optionally, the DAF 800 may comprise a memory 803. In some embodiments, the memory 803 can be configured to store program code that can be executed by the processing circuitry 801 to perform the method described herein in relation to the DAF 800. Alternatively or in addition, the memory 803 can be configured to store any requests, resources, information, data, signals, or similar that are described herein. The processing circuitry 801 may be configured to control the memory 803 to store any requests, resources, information, data, signals, or similar that are described herein.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method for managing access to data stored on a terminal device, the method at the terminal device comprising:
receiving, from a first application executing on the terminal device, a request for access to a first type of stored data;
receiving, as a user input, a first indication of whether the first application is to be allowed: full access to the first type of stored data, partial access to the first type of stored data, or no access to the first type of stored data; and
providing the first application full, partial or no access to the first type of stored data according to the first indication.

2. A method according to claim 1, the method further comprising:
receiving, from a data analysis function, a first set of rules and/or a first trained machine learning model for identifying a subset of the stored data of the first type that is not to be accessed by the first application when partial access to the first type of stored data is allowed.

3. A method according to claim 2, the method further comprising:
receiving, from the data analysis function, an updated first set of rules and/or an updated first trained machine learning model for identifying a subset of the stored data of the first type that is not to be accessed by the first application when partial access is allowed.

4. A method according to claim 1, the method further comprising:
after receiving the request for access to the first type of stored data, requesting a user to indicate whether the first application is to be allowed: full access to the first type of stored data; partial access to the first type of stored data; or no access to the first type of stored data.

5. A method according to claim 1, the method further comprising:
using a first set of rules and/or a first trained machine learning model to identify a subset of the stored data of the first type that is not to be accessed by the first application when partial access is allowed.

6. A method according to claim 5, wherein the step of using the first set of rules and/or the first trained machine learning model is performed prior to both the step of receiving the request and the step of receiving the first indication.

7. A method according to claim 5, wherein the step of using the first set of rules and/or the first trained machine learning model is performed following the step of receiving the first indication.

8. A method according to claim 1, the method further comprising:
receiving, from the first application, a request for access to a second type of stored data;
receiving, as a user input, a second indication of whether the first application is to be allowed: full access to the second type of stored data; partial access to the second type of stored data, or no access to the second type of stored data; and
providing the first application full, partial or no access to the second type of stored data according to the second indication.

9. A method according to claim 8, the method further comprising:
using a second set of rules and/or a second trained machine learning model to identify a subset of the stored data of the second type that is not to be accessed by the first application when partial access to the second type of stored data is allowed.

10. A method according to claim 1, the method further comprising:
receiving, from a second application, a request for access to the first type of stored data;
receiving, as a user input, a third indication of whether the second application is to be allowed: full access to the first type of stored data; partial access to the first type of stored data, or no access to the first type of stored data; and
providing the second application full, partial or no access to the first type of stored data according to the third indication.

11. A method according to claim 10, the method further comprising:
using a third set of rules and/or a third trained machine learning model to identify a subset of the stored data of the first type that is not to be accessed by the second application when the second application is allowed partial access to the first type of stored data.

12. A method according to claim 1, wherein partial access to the first type of stored data comprises access to the stored data of the first type with a subset of the stored data removed, masked or anonymised.

13. A method according to claim 1, wherein partial access to the first type of stored data comprises access to a stored copy of the stored data of the first type with a subset of the stored data removed, masked or anonymized.

14.-17. (canceled)

18. A method for managing access to data stored on a terminal device, the method at a data analysis function comprising:
determining a first set of rules and/or training a first machine learning model, wherein the first set of rules and/or first trained machine learning model is for identifying a subset of stored data of a first type that is not to be accessed by a first application executing on the terminal device in the event that a user of the terminal device indicates the first application is to be allowed partial access to stored data of the first type; and
sending the first set of rules and/or the first trained machine learning model to the terminal device.

19. The method according to claim 18, the method further comprising:
sending an updated first set of rules and/or an updated first trained machine learning model to the terminal device.

20. The method according to claim 18, the method further comprising:
determining a second set of rules and/or training a second machine learning model, wherein the second set of rules and/or second trained machine learning model is for identifying a subset of stored data of a second type that is not to be accessed by the first application in the event that a user of the terminal device indicates the first application is to be allowed partial access to stored data of the second type; and
sending the second set of rules and/or the second trained machine learning model to the terminal device.

21. The method according to claim 18, the method further comprising:
determining a third set of rules and/or training a third machine learning model, wherein the third set of rules and/or third machine learning model is for identifying a subset of stored data of the first type that is not to be accessed by a second application in the event that a user of the terminal device indicates the second application is to be allowed partial access to stored data of the first type; and
sending the third set of rules and/or the third trained machine learning model to the terminal device.

22. The method according to claim 18, wherein the first type of stored data is short message service, SMS, data, image data, video data or contact data, calendar data, call logs, terminal device location information, user files, measurements of the user by one or more sensors in the terminal device, or any other data stored in the terminal device.

23. A terminal device for managing access to data stored on the terminal device, the terminal device configured to:
receive, from a first application executing on the terminal device, a request for access to a first type of stored data;
receive, as a user input, a first indication of whether the first application is to be allowed: full access to the first type of stored data; partial access to the first type of stored data, or no access to the first type of stored data; and
provide the first application full, partial or no access to the first type of stored data according to the first indication.

24. A terminal device according to claim 23, wherein the terminal device is further configured to:
receive, from a data analysis function, a first set of rules and/or a first trained machine learning model for identifying a subset of the stored data of the first type that is not to be accessed by the first application when partial access to the first type of stored data is allowed.

25.-67. (canceled)
